(19) United States
(12) Patent Application Publication
(10) Pub. No.: US 2005/0163887 A1
(43) Pub. Date: Jul. 28, 2005

(54) Method of producing heat stable whey protein and products made therefrom

(75) Inventors: Kamlesh Anand, Shoreview, MN (US); Glenn Ward, Lauderdale, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Land O' Lakes, Inc., Arden Hills, MN (US)

(21) Appl. No.: 10/763,600

(22) Filed: Jan. 23, 2004

(51) Int. Cl. A23C 9/12

(52) U.S. Cl. 426/41

(57) ABSTRACT

A method for producing a heat stable whey protein includes adding an effective amount of a reagent to the whey protein having free mineral ions. The free mineral ions form water-soluble compounds with the reagent. The water-soluble compounds are filtered from the whey protein to reduce the concentration of free minerals and form a heat stable whey protein.

### CROSS REFERENCE TO RELATED APPLICATION(S)

None.

### BACKGROUND OF THE INVENTION

The present invention generally relates to a method for making a heat stable whey protein. More particularly, the present invention relates to a method of removing free mineral ions from whey protein to make the heat stable whey protein. The present invention also includes a heat stable whey protein produced from the inventive method of removing free mineral ions from the whey protein.

Whey is a byproduct of the cheese making process. Whey, an aqueous solution that is separated from curd, contains a significant amount of proteins and free ionic minerals such as calcium and magnesium. The whey is concentrated by removing some of the aqueous portion to produce a whey protein concentrate. Whey protein concentrate is available in a variety of concentrations as an aqueous solution and can also be dried to a powdered form.

Whey protein is a beneficial source of protein in a human's diet because whey protein is one of the most readily assimilated proteins by the human body. As a protein supplement, whey protein is added to foodstuffs to increase protein intake. Body builders ingest whey protein as a supplement to increase the amount of protein in their diet. Infant formula is also supplemented with whey protein to increase the protein intake of infants.

However, when whey protein is heated, in infant formula or any other foodstuff, the whey protein denatures and forms a gritty precipitate. Therefore, it is difficult to incorporate whey protein into infant formula or any other foodstuff that is heated because when the whey protein denatures, the texture of the foodstuff becomes unpalatable.

### SUMMARY OF THE INVENTION

The present invention includes a method for producing heat stable whey protein. The method includes adding an effective amount of a reagent to a solution of whey protein concentrate having free mineral ions. The reagent reacts with the free mineral ions to form water-soluble complexes or compounds or chelates. The water-soluble compounds are filtered from the whey protein to reduce the concentration of the free mineral ions in the whey protein concentrate. The reduced concentration of the free mineral ions in the whey protein makes the whey protein heat stable.

The present invention also includes a heat stable whey protein product produced by the method of removing free mineral ions with a chelating reagent.

### DETAILED DESCRIPTION OF THE PREFERRED EMBODIMENTS

The present invention relates to a method of forming a heat stable whey protein concentrate (WPC). Heat stable whey protein is defined as a whey protein which, when heated in the temp range of about 150° F.-250° F. for about up to 15 minutes, does not aggregate and form a gritty insoluble or undispersible precipitate or gel. The heat stable WPC is dried and added to foodstuffs to increase the foodstuff's protein content.

Whey proteins are heat sensitive proteins and denature when heated specifically in the presence of free divalent ions in the WPC such as calcium and magnesium. What is meant by denaturing is the aggregation which results in the formation of gel/gritty precipitates by whey proteins. Once denatured, whey proteins are not soluble in an aqueous solution and cannot be manipulated back into their original structure or solubility. The solution also becomes opaque. What is meant by undispersible is that a gel or precipitate formed on heating cannot dispersed into solution by gentle manipulation or shaking. Gritty is defined as the presence of grainy or rough or coarse particulates which can be felt on the tongue while tasting.

While the exact mechanism is not known, the presence of free calcium and magnesium ions in the WPC causes the whey proteins to denature and form precipitates when heated. It is believed that free calcium ions have a greater effect than the free magnesium ions in causing the whey proteins to denature. Untreated whey proteins are known to denature at temperatures starting at about 150° F., resulting in the formation of gritty aggregates or precipitates or insoluble gels which render the heated whey protein or foodstuff containing heated whey protein unpalatable.

The method of the present invention employs adding an effective amount of a generally recognized as safe (GRAS) reagent to the WPC to form water soluble complexes or compounds or chelates containing the divalent calcium and magnesium ions. An exemplary reagent is a chelating agent. What is meant by a chelating agent is a chemical compound that bonds with a metal ion such as calcium or magnesium to form a heterogeneous ring.

A preferred chelating agent is a citrate ion that is added to the WPC, preferably as sodium citrate. The sodium citrate is preferably added as twenty weight percent solution to the WPC at a rate of between about one and six grams of dry sodium citrate in solution per liter of a 34 weight percent WPC solution. It will be understood that the concentration of the citrate solution may be varied depending on the concentration of whey protein and that the above description of citrate concentration needed is to be considered as a reference point. For example if the whey protein concentration is decreased the concentration of the citrate solution may also be decreased or the citrate concentration may be kept the same but the rate of addition be decreased.

Other compounds that include citrate that dissociate in an aqueous solution may alternatively be added to the WPC to form the water soluble chelate complexes with the free calcium and magnesium ions including, but not limited to, EDTA (ethylenediamine tetra-acetic acid) citric acid, polyphosphates, potassium citrate. Other chelating agents may also be added to the WPC to form chelate complexes or compounds with the free calcium and magnesium ions including, but not limited to, compounds containing porphorin rings. Besides chelating reagents other compounds that bind the free calcium and magnesium ions can also be used to practice the invention including, but not limited to, ion exchange resins.

The reagent is mixed into the WPC for a selected amount of time so that the reagent is dispersed substantially uniformly throughout the WPC. Although exact mixing time is dependant upon the quantity of WPC, the solubility of the reagent and the mixing equipment used to mix the reagent into the WPC, the reagent is preferably mixed into the WPC for about ten minutes.

With the chelating agent mixed into the WPC, the pH of the solution is adjusted with a base to within a range of about 6.0-8.0 and preferably about between about 7.0 and 7.5. A preferred base is about a ten weight percent sodium hydroxide solution, although other GRAS compounds that dissociate in an aqueous solution to form a hydroxide ion may also be used to adjust the pH of the WPC such as KOH.

The pH of the solution is adjusted to about a neutral pH to expose sulfhydryl groups. After the solution is adjusted to about a neutral pH, the solution is heated to about between 150° F. to 190° F. and preferably about 170° F. for about one to six minutes. Not wishing to be bound to theory, heating in the presence of chelating agent, or under conditions in which free calcium or magnesium are complexed, promotes intramolecular interactions and thereby stabilizes whey proteins against intermolecular interactions thereby preventing aggregation.

The solution is cooled to a selected temperature between about 40° F. and 125° F. and preferably between about 50° F. and 70° F. Once the solution is cooled to the selected temperature, the solution is ultrafiltered. What is meant by ultrafiltering is filtering the solution through a membrane or membranes of a selected pore size under pressure such that the chelate complexes pass through the membranes as a component of the permeate while the whey proteins are unable to pass through the pores of the membranes and are retained as a component of the retentate. Because the chelate complexes pass through the membranes into the permeate, the concentrations of the calcium and magnesium ions are reduced in the WPC whether the concentrations are based upon free ions, bound ions or free and bound ions in the WPC. In one example, the ultrafiltering feed pressure was approximately 80 psi and had a temperature in the range of approximately 50° F.-70° F. with a concentration of approximately 8-12% solids with 2-5% protein. The outlet pressure was approximately 30 psi at a temperature range of 120° F.-130° F. with an exit concentration of 20-30% solids with 12-20% protein.

The retentate may be optionally diafiltered to remove additional free calcium and magnesium ions and/or chelate complexes. What is meant by diafiltration is the processing of the WPC through a membrane under pressure where the aqueous portion of the WPC and the chelate complex pass through pores of a selected size in the membrane as permeate while the whey proteins are retained by the membrane as retentate. As permeate is removed from the WPC, an equal volume of water is fed into the WPC so that the volume of the retentate remains constant throughout the diafiltration process. In one example, the diafiltration feed pressure was approximately 80 psi with the concentration entering the diafiltration of approximately 5-20% solids with a protein concentration of 3-15%. The diafiltration outlet pressure was approximately 30 psi with the concentration of 15-30% solids was 12-26% protein.

The filtered WPC is optionally spray dried into a powder form. An exemplary dryer includes a six-foot diameter vertical laboratory/experimental Rogers spray dryer from C. E. Rogers Company of Mora, Minn. using an inlet temperature of approximately 350° F., an exhaust temperature of approximately 178° F. The feed pressure was approximately 200 psi, and the line pressure to the spray nozzle was approximately 1000 psi. The spray nozzles used were 042 SD spray drying nozzles manufactured by Delavan Spray Technologies of the United Kingdom.

With the reduced divalent calcium and magnesium ion concentrations, the WPC is heat stable and can be added as a protein supplement to a foodstuff. The foodstuff can be heated and/or reheated and the whey protein will not denature and form the gritty precipitate.

The heat stable WPC of the present invention can be added in an effective range based upon weight percent to a foodstuff where the foodstuff can be heated to about 250° F. for 15 minutes in a pressure vessel without the whey proteins denaturing and forming a precipitate. Preferably, the WPC is added to the foodstuff in a range of less than or equal to six weight percent of the foodstuff.

It has been discovered that the process of the present invention and the resulting products manufactured by the process are heat stable and are able to be processed under heat conditions which normally would cause undesirable coagulation and precipitation of WPC solutions. The following Examples are illustrative only and are not intended to limit the present invention in any way.

### EXAMPLE 1

A twenty weight percent solution of sodium citrate was added at a rate of three grams of sodium citrate per liter to eighty gallons of 34 weight percent WPC solution having a temperature of about 40° F. The solution was mixed for about ten minutes to provide a substantially homogenous sodium citrate concentration throughout the WPC.

The pH of the WPC was adjusted to about 7.0 with a ten weight percent solution of sodium hydroxide. The mixture of WPC, sodium citrate and sodium hydroxide was heated to 170° F. and maintained at 170° F. for about three minutes.

The solution was cooled to about 70° F. and processed through an ultrafiltration unit having 5,000 molecular weight cut off membranes at about 80 psig. The solution was processed through the ultrafiltration unit until the volume of the solution was reduced to about one fifth of the initial volume entering the ultrafiltration unit.

The volume of the solution was increased to three times the ultrafiltration retentate volume with water processed through a reverse osmosis unit. The solution was diafiltered for approximately 23 minutes at approximately 70° F., 80 psig through 5,000 molecular weight cut off membranes. The same unit was used for both ultrafiltration and diafiltration. The solution was spray dried to a powdered form having eighty weight percent whey protein (WPC 80) with a 6 ft diameter laboratory/experimental vertical Rogers spray dryer manufactured by C. E. Rogers Company.

The dried treated WPC was added to water at concentrations of 4 weight percent, 5 weight percent and 6 weight percent. Each of the solutions was heated in an autoclave at 250° F. for fifteen minutes and drained through a #70 sieve having 212 micrometer openings to determine the amount of treated WPC that denatured and had the following results.

TABLE 1

| Wt. % WPC | Precipitation |
|---|---|
| 4 | Some soft precipitate formed that easily |
| | broke into yogurt-like texture and no |
| | large clumps |
| 5 | More precipitate than the 4 wt % batch |
| | with no large clumps and yogurt-like |
| | texture |
| 6 | More precipitate than the 5 wt % batch |
| | with larger clumps and yogurt-like |
| | texture |

The above table indicates that heat stable WPC when reconstituted between 4-6% concentrations and subjected to retort or aseptic like conditions formed only a soft precipitate which easily dispersed upon shaking indicating that heat treated WPC is heat stable up to 6% concentration of WPC 80. The absence of stable precipitate confirms the heat stability of the WPC.

### EXAMPLE 2

A twenty weight percent solution of sodium citrate was added at a rate of three grams of sodium citrate per liter to one hundred gallons of 34 weight percent WPC having a temperature of about 40° F. The solution was mixed for about ten minutes to provide a homogenous sodium citrate concentration throughout the WPC.

The pH of the WPC was adjusted to about 7.5 with a ten weight percent solution of sodium hydroxide. The mixture of WPC, sodium citrate and sodium hydroxide was heated, cooled, ultrafiltered, diafiltered and spray dried at the same process conditions using the same process equipment as described in Example 1.

The dried treated WPC was added to water at concentrations of 4 weight percent, 5 weight percent and 6 weight percent. Each of the solutions was heated in an autoclave at 250° F. for fifteen minutes and drained through a #70 sieve having 212 micrometer openings to determine the amount of treated WPC that denatured and had the following results.

TABLE 2

| Wt. % WPC | Precipitation |
|---|---|
| 4 | One small piece of precipitate |
| 5 | No precipitate |
| 6 | About 20 small flecks of precipitate |

The above table indicates that heat stable WPC when reconstituted between 4-5% concentrations and subjected to retort or aseptic like conditions exhibited minimum change in the appearance of WPC solutions indicating high heat stability at up to 5% solution. At 6% concentration of WPC 80, there is increase in the opaqueness but no gritty precipitate. Thus heat stable WPC produced under the above conditions can be used up to 6% concentration of WPC 80 in a beverage without undesirable precipitation.

### EXAMPLE 3

Regular thirty-four weight percent WPC was ultrafiltered, diafiltered and spray dried to a WPC 80 at the same process conditions with the same process equipment as described in Example 1.

The dried WPC 80 was added to water at concentrations of 4 weight percent, 5 weight percent and 6 weight percent. Each of the solutions was heated in an autoclave at 250° F. for fifteen minutes and drained through a #70 sieve having 212 micrometer openings to determine the amount of WPC that denatured and had the following results.

TABLE 3

| Wt. % WPC | Precipitation |
|---|---|
| 4 | Some soft precipitate breakable into a |
| | yogurt-like texture |
| 5 | More precipitate than made from 4 wt. % |
| | batch that breaks into a yogurt-like |
| | texture and no large globs |
| 6 | More precipitate than the 5 wt. % batch |
| | that produced large globs |

WPC 80 starts giving undesirable gritty, undispersible gel like structure incapable of being redispersed by shaking when reconstituted in the range of 4-6% concentration and then heated in a retort or aseptic like conditions. Thus regular WPC 80 cannot be used in products which require heat processing without forming a precipitate.

### EXAMPLE 4

The heat stable WPC 80 made under the process conditions in Example 2 was used as an ingredient in a milk substitute. 22.63 grams of the heat stable WPC 80 was combined with 42.21 grams of edible lactose, 0.245 grams of cream flavorant, 1.15 liters of water, 0.7 liters of skim milk and 43.57 grams of 36 DE corn syrup solids. The mixture was stirred until the solids were dissolved where the mixture had a pH of 6.89.

The mixture was heated in a water bath to 125° F. With the mixture stabilized at 125° F., 41.35 grams of vegetable oil was added while the mixture was stirred with a wire whisk. The mixture including the oil was homogenized in a microfluidics HC 800 homogenizer (microfluidics, a division of MFIC Corporation of Newton, Mass.) and then cooled to between 40° F. and 105° F. Small, very soft clumps formed on the surface while cooling.

A sample of the milk substitute was heated in an autoclave at 250° F. for fifteen minutes and poured through a #70 sieve having 212 micrometer openings. The sieve retained no precipitate.

One skilled in the art will recognize that the heat stable WPC may be added to many foodstuffs that are subjected to heating and reheating including but not limited to infant formula, dairy based beverages, imitation milk and soups. Further, the heat stable WPC can be added as a protein supplement to any foodstuff that is ultra high temperature (UHT) treated. What is meant by UHT treatment is to heat the foodstuff to at least 282° F. and to hold the foodstuff at that temperature for several seconds. Subsequently, the foodstuff is cooled to about 70° F. in a pressurized system, and then preferably aseptically sealed to preserve a longer shelf life.

Although the present invention has been described with reference to preferred embodiments, workers skilled in the art will recognize that changes may be made in form and detail without departing from the spirit and scope of the invention.

1. A method for producing a heat stable whey protein, the method comprising:
providing a solution of whey protein having free mineral ions;
adding an effective amount of a reagent to the whey protein wherein the reagent reacts with the free mineral ions and forms water-soluble compounds; and
filtering the water-soluble compounds from the whey protein to reduce the concentration of free mineral ions and form the heat stable whey protein.

2. The method of claim 1 and wherein the free mineral ions comprise calcium ions and magnesium ions.

3. The method of claim 1 and wherein the reagent comprises a chelating agent.

4. The method of claim 3 and wherein the chelating agent comprises a citrate ion.

5. The method of claim 3 and wherein the chelating agent comprises sodium citrate.

6. The method of claim 5 and wherein sodium citrate is added at a rate of between about 1 gram and 6 grams of sodium citrate per liter of whey protein.

7. The method of claim 1 and further comprising adjusting a pH of the whey protein concentrate and the reagent mixture to about neutral.

8. The method of claim 7 and wherein a hydroxide ion is added to adjust the pH of the whey protein concentrate and reagent mixture.

9. The method of claim 1 and further comprising heating the whey protein concentrate to about between about 150° F. and 190° F. prior to filtering the whey protein concentrate.

10. The method of claim 9 and further comprising maintaining the temperature of the whey protein concentrate at a temperature of between about 150° F. 190° F. for about between about one and three minutes prior to filtering the whey protein concentrate.

11. The method of claim 1 and wherein filtering comprises ultrafiltration.

12. The method of claim 11 and wherein filtering further comprises diafiltration.

13. The method of claim 1 and further including spray drying the filtered whey protein to form a whey protein concentrate.

14. A heat stable food product comprising an effective amount of whey protein produced by the method of claim 1 characterized by no precipitate retained when passed through a sieve having 212 micrometer openings.

15. The heat stable food product of claim 14 and wherein the food product is heated to between about 150° F. and 250° F. for up to 15 minutes.

16. The heat stable food product of claim 14 and wherein the heat stable food product includes up to 6 weight percent whey protein.

17. A heat stable whey protein produced by the method of claim 1 characterized by the whey protein's ability to not form a precipitate in a temperature range of between about 150° F. and 250° F. for up to 15 minutes.

18. A heat stable whey protein produced by the method of claim 1 characterized by the whey protein's ability to not form an aggregate in a temperature range of between about 150° F. and 250° F. for up to 15 minutes.

19. A heat stable whey protein produced by the method of claim 1 characterized by the whey protein's ability to not gel when added to a liquid when the liquid is heated in a temperature range of between about 150° F. and 250° F. for up to 15 minutes.

20. The heat stable whey protein of claim 19 wherein the heat stable whey protein is added to the solution in a concentration up to 6 weight percent.

21. A method of removing divalent minerals from whey protein solution, the method comprising:
mixing an effective amount of a reagent with the whey protein solution and wherein the reagent bonds with the divalent minerals to form water-soluble complexes within the whey protein solution; and
ultrafiltering the water-soluble complexes from the whey protein.

22. The method of claim 21 and wherein the reagent comprises a chelating agent.

23. The method of claim 22 and wherein the chelating agent comprises a citrate ion.

24. The method of claim 22 and wherein the chelating agent comprises sodium citrate.

25. The method of claim 24 and wherein the sodium citrate is added at a rate of about 1 to 6 grams of dry sodium citrate per liter of whey protein.

26. The method of claim 21 and further comprising adjusting a pH of the mixture of the reagent and the whey protein solution to about neutral prior to ultrafiltering the mixture.

27. The method of claim 26 and wherein a hydroxide ion is added to adjust the pH of the mixture.

28. The method of claim 21 and further comprising heating the mixture of the reagent and the whey protein solution to between about 150° F. and 190° F. prior to ultrafiltering the mixture.

29. The method of claim 28 and wherein the mixture is maintained at between about 150° F. and 190° F. for between about one and three minutes.

30. The method of claim 21 and further comprising diafiltering the water-soluble complexes from the whey protein solution after ultrafiltering the water-soluble complexes from the concentrated whey protein.

31. The method of claim 21 and further comprising spray drying the whey protein solution after the water-soluble complexes are removed from the whey protein solution to form a whey protein concentrate.

32. A method of producing a heat stable whey protein suitable for use in foodstuffs for human consumption, the method comprising:
providing a whey protein solution having free divalent minerals;
adding an effective amount of a reagent to the whey protein solution and wherein the reagent forms water-soluble complexes with the free divalent minerals; and
ultrafiltering the water-soluble complexes from the whey protein solution wherein reducing the concentration of the free divalent minerals within the whey protein solution makes the whey protein solution heat stable for use in foodstuffs for human consumption.

33. The method of claim 32 wherein the reagent comprises a chelating agent.

34. The method of claim 33 and wherein the chelating agent comprises a citrate ion.

35. The method of claim 33 and wherein the chelating agent comprises sodium citrate.

36. The method of claim 35 and wherein citrate is added to the whey protein solution at a rate of between about 1 and 6 grams of sodium citrate per liter of solution.

37. The method of claim 32 and further comprising adjusting a pH of the mixture of the reagent and the whey protein solution to about neutral prior to ultrafiltering the mixture.

38. The method of claim 32 and further comprising heating the mixture of reagent and whey protein solution to between about 150° F. and 190° F. prior to ultrafiltering the mixture.

39. The method of claim 38 and wherein the mixture is maintained at between about 150° F. and 190° F. for between about one and three minutes.

40. The method of claim 32 and further comprising diafiltering the whey protein solution after ultrafiltering the whey protein.

41. The method of claim 32 and further comprising spray drying the ultrafiltered whey protein solution to form a whey protein concentrate.
